(19) United States
(12) Patent Application Publication
(10) Pub. No.: US 2026/0307728 A1
(43) Pub. Date: Oct. 8, 2026

(54) ROOF STRUCTURE FOR VEHICLE

(71) Applicants: Hyundai Motor Company, Seoul (KR); Kia Corporation, Seoul (KR)

(72) Inventors: Byeongkyu Kwon, Hwaseong-si (KR); Hae Hoon Lee, Hwaseong-si (KR); Hoyeon Kim, Hwaseong-si (KR)

(21) Appl. No.: 19/402,498

(22) Filed: Nov. 26, 2025

(30) Foreign Application Priority Data
Apr. 2, 2025 (KR) 10-2025-0042554
Jun. 5, 2025 (KR) 10-2025-0073503

(51) Int. Cl. B62D 25/06; B60R 13/04; B62D 27/02

(52) U.S. Cl. CPC B62D 25/06; B60R 13/04; B62D 27/023

(57) ABSTRACT

A roof structure may include side roof panels, a high-roof panel connected to the side roof panels disposed on both lateral sides of the high-roof panel, and the high-roof panel being disposed at a height difference from an upper portion of a vehicle body by the side roof panels, and transverse direction reinforcement members connected to a lower portion of the high-roof panel along the front-rear direction of the vehicle body, and longitudinal direction reinforcement members connected to the lower portion of the high-roof panel.

### CROSS-REFERENCE TO RELATED APPLICATION

This application claims priority to and the benefit of Korean Patent Application No. 10-2025-0042554 filed with the Korean Intellectual Property Office on Apr. 2, 2025, and Korean Patent Application No. 10-2025-0073503 filed with the Korean Intellectual Property Office on Jun. 5, 2025, the entire contents of which are incorporated herein by reference.

### TECHNICAL FIELD

The present disclosure relates to a roof structure applicable to the production of various vehicle bodies.

### BACKGROUND

Recently, the vehicle industry has been introducing a new concept of future mobility vision for realizing a dynamic, human-centered future city. One of these future mobility solutions is a purpose-based mobility (Purpose Built Vehicle (PBV)).

PBV is an example of an electric vehicle (EV)-based environment-friendly mobility vehicle. These PBVs can provide users with a variety of customized services during their travel from departure to destination.

PBV can be manufactured in various shapes and sizes depending on the user’s use case. For example, PBV can be used as a hailing or delivery type vehicle.

PBV can be manufactured as a high-roof type vehicle to provide users with a wider vehicle interior space.

For example, a high roof type PBV can be manufactured by manufacturing a dedicated high roof type body from the initial design stage (e.g., inline method).

However, although it can secure a wide vehicle interior space and inline mass production, it cannot share the basic vehicle body of various vehicle types other than the high roof type, which can cause an increase in vehicle development period and investment cost.

The information contained in this background section is intended to enhance understanding of the background of the present disclosure and may include matters that are not conventional art already publicly known, available, or in use.

### SUMMARY

The disclosed example embodiments relate to a vehicle body, and more particularly, the present disclosure relates to a roof structure applicable to the production of various vehicle bodies.

Some embodiments of the present disclosure may provide a roof structure that can provide a wide vehicle interior space to the user and enable the commonization of the basic vehicle body of various vehicle types.

Some embodiments of the present disclosure may provide a roof structure that can enhance the skeletal strength of a vehicle body.

A roof structure according to some disclosed embodiments may include: a high roof panel that is connected to side roof panels disposed on both sides and is disposed at a height difference from an upper portion of a vehicle body by the side roof panels; and transverse direction reinforcement members connected to the lower portion of the high roof panel along the front-rear direction of the vehicle body, and longitudinal direction reinforcement members connected to the lower portion of the high roof panel.

The roof structure may further include transverse direction extension members connected to both ends of the transverse direction reinforcement members and connected along the vertical direction to the inner surface of the side roof panel.

The roof structure may further include side reinforcement members that are connected to the outer surface of the side roof panel and connected to the upper portion of the vehicle body through the lower portion of the side roof panel.

The longitudinal direction reinforcement members may be disposed between the transverse direction reinforcement members and may be connected to the transverse direction reinforcement members by joint forming parts formed at both front and rear ends.

The roof structure may further include a garnish panel connected to the side reinforcement members.

The vehicle body may be equipped with a common vehicle body with a roof side disposed an upper portion of the side structure.

A roof structure according to the disclosed embodiments may include: a high roof panel disposed at a height difference from a roof side of a vehicle body; a side roof panel connected to both sides of the high roof panel and connected to a roof side; and side reinforcement members that are connected to the side roof panel along the front-rear direction and vertical direction of the vehicle body and are connected to the roof side through the lower portion of the side roof panel.

The side reinforcement members may include: an upper portion reinforcement member connected along the front-rear direction of the vehicle body to the upper portion of the side roof panel and connected to both sides of the high roof panel; a lower portion reinforcement member connected to the lower portion of the side roof panel along the front-rear direction of the vehicle body; and vertical side reinforcement members to the upper portion reinforcement member and the lower portion reinforcement member connected along the vertical direction.

The sides of the high roof panel, the upper portion of the side roof panel, and the upper portion of the upper portion reinforcement member may be connected through a 3-layer joint.

The lower portion reinforcement member may be connected to the roof side through the lower portion of the side roof panel and may be provided as a reinforcing axis that reinforces the strength of a bending axis along the forward and backward direction of the vehicle body.

An upper closed section may be formed between the side roof panel and the upper portion reinforcement member.

A lower closed section may be formed between the side roof panel and the lower portion reinforcement member.

At the position corresponding to the vertical side reinforcement members, transverse direction extension members may be connected in the vertical direction to the inner surface of the side roof panel.

Inner closed sections may be formed between the transverse direction extension members and the side roof panels.

Outer closed sections may be formed between the vertical side reinforcement members and the side roof panel.

The side reinforcement members may further include a rear side reinforcement member connected to the rear of the high roof panel and the rear of the side roof panel, and connected to the rear of the upper portion reinforcement member and the rear of the lower portion reinforcement member.

The upper portion reinforcement member may include a front side extension member provided at the front and connected to the front of the lower portion reinforcement member.

The lower portion reinforcement member may include a rear side extension member provided at the rear and connected to the rear side reinforcement member.

The rear side reinforcement member may include a front joint member connected to the rear of the upper portion reinforcement member and the rear side extension member, and a rear joint member connected to the front joint member.

The roof side, the side roof panel, and the lower portion reinforcement member may be connected through a 3-layer joint.

The roof structure may further include a garnish panel connected to the upper portion reinforcement member and the lower portion reinforcement member.

The garnish panel may be connected via mounting clips to mounting holes formed in the upper portion reinforcement member and the lower portion reinforcement member.

For a roof structure according to some disclosed embodiments, because the basic vehicle body of various vehicle types can be shared, the development period and investment cost of the vehicle body can be reduced.

For a roof structure according to some disclosed embodiments, the skeletal strength and watertight performance of the vehicle body can be strengthened.

Advantages that can be obtained or expected from the disclosed embodiments are disclosed directly or implicitly in the detailed description of the present disclosure. That is, various advantages expected according to the example embodiments of the present disclosure will be disclosed in the detailed description that follows.

### BRIEF DESCRIPTION OF THE DRAWINGS

The drawings are intended for reference in describing example embodiments of the present disclosure, and therefore technical ideas of the disclosed example embodiments should not be construed as necessarily limited to the accompanying drawings.

FIG. 1 is a side view illustrating a vehicle body applied to a roof structure according to an example embodiment.

FIG. 2 is a perspective view illustrating a roof structure according to an example embodiment.

FIGS. 3 to 5 are various exploded perspective views illustrating roof structures according to some example embodiments.

FIG. 6 is a cross-sectional view along line A-A of FIG. 1.

FIG. 7 is an exploded perspective view illustrating a joint structure of a longitudinal direction reinforcement member configured to be applied to a roof structure according to an example embodiment.

FIGS. 8A and 8B are a perspective view and an exploded perspective view illustrating side reinforcement members applied to a roof structure according to an example embodiment.

FIGS. 9 and 10 are drawings for explaining an assembly process of a roof structure according to some example embodiments.

FIG. 11 is a drawing for explaining an operation of the roof structure according to some example embodiments.

The drawings referenced above are not necessarily drawn to scale, and may be understood as presenting rather simplified representations of various features that illustrate some principles of some example embodiments. For example, certain design features of some embodiments, including specific dimensions, direction, position, and shape, may be determined in part by the particular intended application and usage environment.

### DETAILED DESCRIPTION OF ILLUSTRATIVE EMBODIMENTS

Hereinafter, with reference to the attached drawings, example embodiments of the present disclosure will be described in detail so that a person having ordinary skill in the art to which the present disclosure pertains can easily practice embodiments of the present disclosure. As those skilled in the art would may realize, the described example embodiments may be modified and combined in various different ways for other embodiments, without departing from the spirit or scopes of the present disclosure.

Terminology used herein is for the purpose of describing particular example embodiments and is not intended to necessarily limit the present disclosure. As used herein, singular forms may be intended to include plural forms as well, unless the context clearly indicates otherwise.

It should also be understood that the terms “comprise” and/or “include” as used herein indicate the presence of stated features, integers, steps, operations, elements and/or components, but do not preclude the presence or addition of one or more other features, integers, steps, operations, components, and/or groups thereof. As used herein, the term “and/or” includes any and all combinations of one or more of the associated listed items.

In this specification, the term “connected” indicates a physical relationship between two components where the components are directly connected to each other by welding, SPR (Self Piercing Rivet), FDS (Flow Drill Screw), structural adhesive, etc., or indirectly connected through one or more intermediate components.

As used herein, “vehicle”, “vehicular”, “automotive” or other similar terms as used herein may generally refer to passenger vehicles, sports cars, sport utility vehicles (SUVs), buses, trucks, tractors, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

Hereinafter, some example embodiments of the present disclosure will be described in detail with reference to the attached drawings.

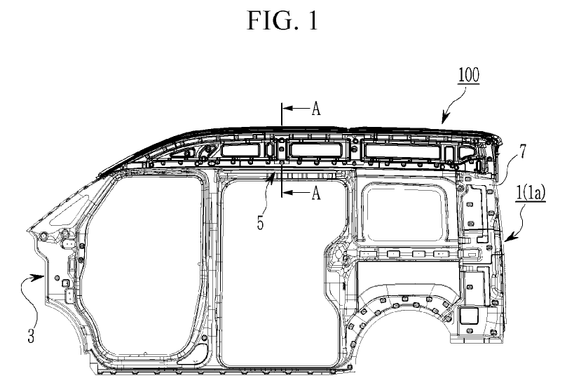

FIG. 1 is a side view illustrating a vehicle body applied to a roof structure according to an example embodiment.

Referring to FIG. 1, a roof structure 100 according to an example embodiment may be applied, for example, to a vehicle body 1 of a purpose-based mobility vehicle (Purpose Built Vehicle: hereinafter referred to as “PBV”).

The PBV may be utilized as an electric vehicle-based life module vehicle that provides various customized services to users during the time they travel from the departure point to the destination.

In one example, the PBV may be manufactured as a one box type design with a wide vehicle interior space. The PBV may also apply facing-type seats to the vehicle interior space. The vehicle body of the PBV may be manufactured in various shapes and sizes depending on the purpose of use of the PBV.

The vehicle body of the PBV may be utilized as a variety of vehicle types, such as a hailing vehicle as a means of transporting occupants, a delivery vehicle for transporting goods, and a special vehicle such as an ambulance, for example.

In this specification, the reference direction for describing the components below may be set as the vehicle body front-back direction (e.g., vehicle body length direction or longitudinal direction), vehicle width direction (e.g., lateral direction or left-right direction), and vertical direction (e.g., height direction) with the vehicle body as reference.

In this specification, the “top”, “upper”, or “upper face” of a component refers to an end, section, or face of the component that is relatively higher in the drawing, and the “bottom”, “lower”, or “lower face” of a component refers to an end, section, or face of the component that is relatively lower in the drawing.

In this specification, the term “end” of a component (e.g., one end, the other end, or both ends, etc.) refers to an end of the component in any one direction, and the term “end portion” of a component (e.g., one end portion, the other end portion, both end portions, the front end portion, or the rear end portion, etc.) refers to a portion of the component that includes that end.

The roof structure 100 according to an example embodiment is a high roof structure to provide a wide vehicle interior space to the user.

The roof structure 100 according to an example embodiment may be mounted on an upper portion of a side structure 3 of a vehicle body 1.

In some embodiments, the side structure 3 is configured to form a cabin or luggage room of a wide vehicle interior space inside the vehicle body 1. In some embodiments, the side structure 3 may include doors and windows, etc. according to the required configuration depending on the type of vehicle.

For example, the side structure 3 may be equipped with vehicle doors such as sliding doors and swing doors. The side structure 3 may be equipped with an openable window or fixed glass, or may not have a window mounted depending on the vehicle type.

The roof structure 100 according to an example embodiment may be manufactured separately from the roof assembly process and may provide a structure that may be mounted on the upper portion of the vehicle body 1 in the vehicle body assembly process (e.g., inline process).

The roof structure 100 according to an example embodiment may provide a structure that may be shared by vehicle bodies 1 of various vehicle types, for example, a basic vehicle body that is not a high roof type.

Generally, a vehicle body with a high roof structure may secure a higher vehicle body height, wider vehicle interior space, and an increased rear opening, but the strength of the vehicle body may be weakened.

Therefore, there is a need for development of a roof structure 100 that may enhance the strength of the vehicle body 1, such as torsional strength.

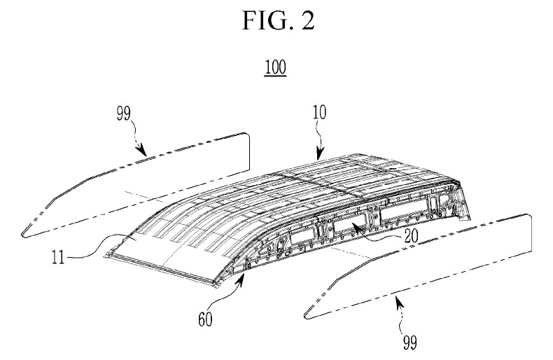

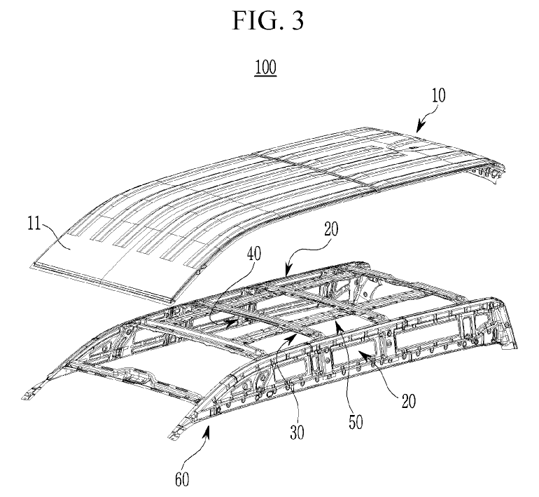

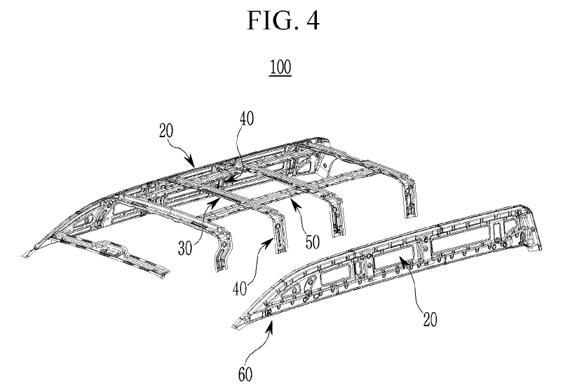

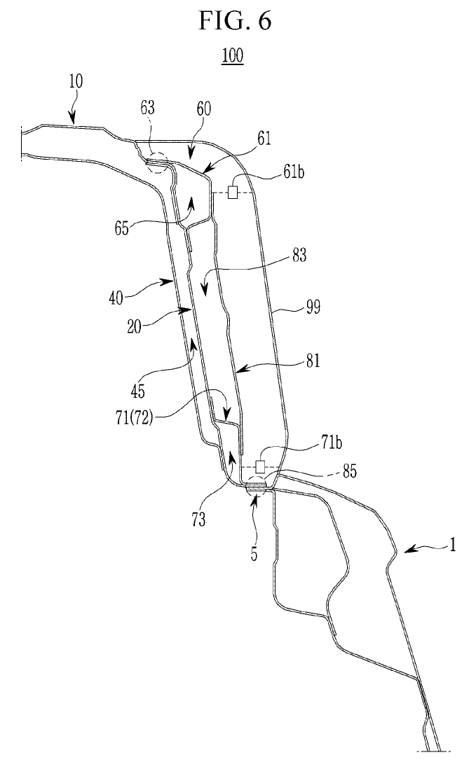

FIG. 2 is a perspective view illustrating a roof structure according to an example embodiment. FIGS. 3 to 5 are various exploded perspective views illustrating roof structures according to some example embodiments. FIG. 6 is a cross-sectional view along line A-A of FIG. 1.

Referring to FIGS. 2 to 6, the roof structure 100 according to an example embodiment may include a high roof panel 10, a side roof panel 20, transverse direction reinforcement members 30, transverse direction extension members 40, longitudinal direction reinforcement members 50, and side reinforcement members 60.

In an example embodiment, the high roof panel 10 may be arranged at a height difference from the upper portion of the vehicle body 1.

The high roof panel 10 may be provided with one panel in one example, or with at least two panels in another example. The high roof panel 10 may include a slope portion 11 that slopes downward from the center toward the front of the vehicle body 1.

The high roof panel 10 may be used to mount PBV operational modules, such as sensors and antennas.

In an example embodiment, the vehicle body 1 may be provided as a common vehicle body 1a having a roof side 5 arranged on the upper portion of the side structure 3 as illustrated in FIG. 1.

In some embodiments, the common vehicle body 1a is a basic vehicle body that is not of the high roof type, and in some embodiments, may be referred to as a vehicle body that is not replaced even if the vehicle type of the PBV is changed.

In an example embodiment, the side roof panel 20 may be arranged on each side of the high roof panel 10 along the vehicle body length direction.

In some embodiments, the side roof panel 20 is connected to both sides of the high roof panel 10, and may be connected to the roof side 5 of the vehicle body 1.

In an example embodiment, the transverse direction reinforcement members 30, the transverse direction extension members 40, and the longitudinal direction reinforcement members 50 may be configured to reinforce the roof strength of the high roof panel 10 and the side roof panel 20.

In some embodiments, the transverse direction reinforcement members 30 may be connected along the vehicle width direction to the lower portion (or lower surface) of the high roof panel 10, and may be spaced apart along the front-rear direction of the vehicle body. The transverse direction reinforcement members 30 may be provided in a shape formed downward on both sides along the front-rear direction of the vehicle body.

In some embodiments, the transverse direction extension members 40 may be connected to both ends of the transverse direction reinforcement members 30 and may be connected along the vertical direction to the inner surface of the side roof panel 20. The transverse direction extension members 40 may be provided in a shape formed in the vehicle width direction on both sides along the front-rear direction of the vehicle body.

In some embodiments, the longitudinal direction reinforcement members 50 may be connected to the transverse direction reinforcement members 30 along the front-rear direction of the vehicle body and may be connected to the lower portion of the high roof panel 10.

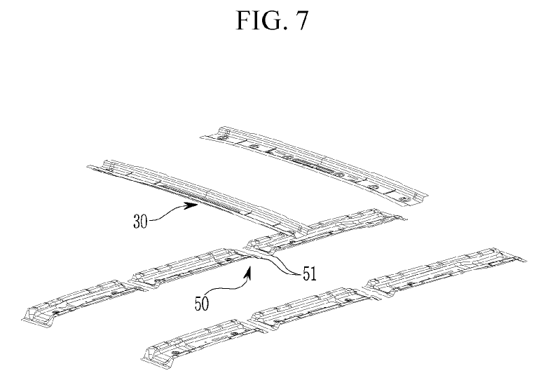

FIG. 7 is an exploded perspective view illustrating a joint structure of a longitudinal direction reinforcement member configured to be applied to a roof structure according to an example embodiment.

In some embodiments, the longitudinal direction reinforcement members 50, as shown in FIG. 7, are disposed between the transverse direction reinforcement members 30 and may be connected to the transverse direction reinforcement members 30 by joint forming parts 51 formed at both front and rear ends. The longitudinal direction reinforcement members 50 may be provided in a shape formed downward on both sides along the vehicle width direction.

In an example embodiment, the side reinforcement members 60 may be configured to reinforce the strength of the side roof panel 20. In an example embodiment, the side reinforcement members 60 may be configured to reinforce the mounting strength and connection strength of the roof structure 100 to the roof side 5.

In some embodiments, the side reinforcement members 60 may be connected to the outer surface of the side roof panel 20 and may be connected to the roof side 5 through the lower portion of the side roof panel 20. The side reinforcement members 60 may be connected to the outer surface of the side roof panel 20 along the front-rear direction and vertical direction of the vehicle body.

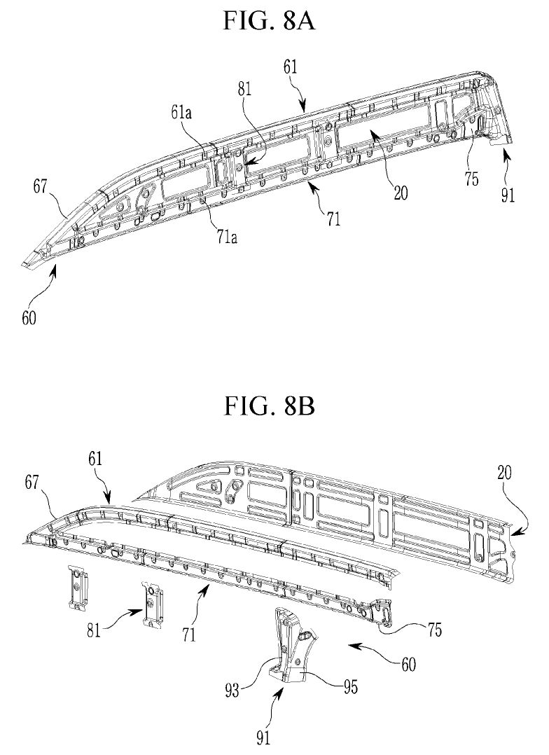

FIGS. 8A and 8B are a perspective view and an exploded perspective view illustrating side reinforcement members applied to a roof structure according to an example embodiment.

Referring to FIGS. 3, 8A and 8B, the side reinforcement members 60 according to some embodiments may include an upper portion reinforcement member 61, a lower portion reinforcement member 71, vertical side reinforcement members 81, and a rear side reinforcement member 91.

In some embodiments, the upper portion reinforcement member 61 may be connected to the upper portion of the side roof panel 20 along the front-rear direction of the vehicle body and may be connected to both sides of the high roof panel 10. The upper portion reinforcement member 61 may be provided with a shape formed in the vehicle width direction at the upper and lower portions.

Referring to FIG. 6, in some embodiments, both sides of the high roof panel 10, the upper portion of the side roof panel 20, and the upper portion of the upper portion reinforcement member 61 may be connected via a 3-layer joint 63.

In some embodiments, an upper closed section 65 may be formed along the front-rear direction of the vehicle body between the side roof panel 20 and the upper portion reinforcement member 61. That is, the joint portion of the side roof panel 20 and the upper portion reinforcement member 61 may be provided as a closed cross-section by the upper closed section 65.

The lower portion reinforcement member 71 may be connected to the lower portion of the side roof panel 20 along the front-rear direction of the vehicle body. The lower portion reinforcement member 71 may be provided with a shape formed in the vehicle width direction at the upper and lower portions.

Referring to FIG. 6, a lower closed section 73 may be formed between the side roof panel 20 and the lower portion reinforcement member 71. That is, the joint portion of the side roof panel 20 and the lower portion reinforcement member 71 may be provided as a closed cross-section by the lower closed section 73.

The upper portion reinforcement member 61 may include a front side extension member 67 provided at the front end. The front side extension member 67 may be provided with a shape corresponding to the shape of the slope portion 11 of the high roof panel 10. The front side extension member 67 may be connected to the front portion of the lower portion reinforcement member 71.

The lower portion reinforcement member 71 may include a rear side extension member 75 provided at the rear end of the lower portion reinforcement member 71. The rear side extension member 75 may be connected to the rear side reinforcement member 91, which will be described below.

In some embodiments, the vertical side reinforcement members 81 may be configured to connect the joint cross-sections of the upper portion reinforcement member 61 and the lower portion reinforcement member 71 along the vertical direction.

The vertical side reinforcement members 81 may be connected to the upper portion reinforcement member 61 and the lower portion reinforcement member 71 along the vertical direction. The vertical side reinforcement members 81 may be provided in a shape formed in the vehicle width direction on both sides along the front-rear direction of the vehicle body.

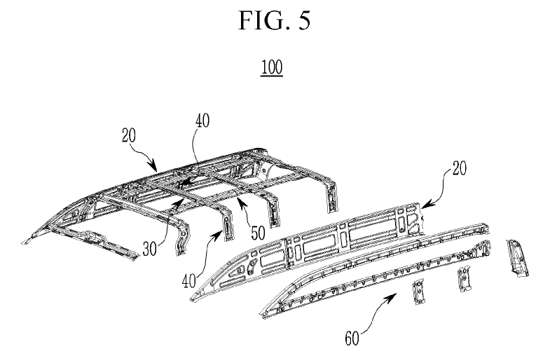

Referring to FIGS. 5 and 6, the vertical side reinforcement members 81 may be connected to the upper portion reinforcement member 61 and the lower portion reinforcement member 71 along the vertical direction at positions corresponding to the transverse direction extension members 40.

At positions corresponding to the vertical side reinforcement members 81, the transverse direction extension members 40 may be connected to the inner surface of the side roof panel 20 along the vertical direction.

Referring to FIG. 6, in some embodiments, inner closed sections 45 may be formed between the transverse direction extension members 40 and the side roof panels 20. That is, the joint portion of the transverse direction extension members 40 and the side roof panel 20 may be provided as a closed cross-section by the inner closed sections 45.

In some embodiments, outer closed sections 83 may be formed between the vertical side reinforcement members 81 and the side roof panels 20. That is, the joint portion of the vertical side reinforcement members 81 and the side roof panel 20 may be provided as a closed cross-section by the outer closed sections 83. The outer closed sections 83 may be disposed at positions corresponding to the inner closed sections 45.

As shown in FIG. 6, in some embodiments, in the connection structure of the upper portion reinforcement member 61, the lower portion reinforcement member 71, and the vertical side reinforcement members 81, the lower portion reinforcement member 71 may be connected to the roof side 5 of the vehicle body 1.

In some embodiments, the lower portion of the lower portion reinforcement member 71 may be connected to the lower portion of the side roof panel 20, and the lower portion of the side roof panel 20 may be connected to the roof side 5.

In some embodiments, the lower portion of the lower portion reinforcement member 71, the lower portion of the side roof panel 20, and the roof side 5 may be connected via a 3-layer joint 85.

In some embodiments, the lower portion reinforcement member 71 may be provided as a reinforcing axis 72 that reinforces the skeletal strength of the vehicle body 1 along the front-rear direction of the vehicle body by being connected to the roof side 5 of the vehicle body 1 through the lower portion of the side roof panel 20. That is, the lower portion reinforcement member 71 may reinforce the strength of a part of the vehicle body 1 where the skeletal strength is weak, for example, the roof side 5 connected to the lower portion of the side roof panel 20.

Referring to FIGS. 3, 8A and 8B, in some embodiments, the rear side reinforcement member 91 may be connected to the upper portion of the rear pillar 7 in the side structure 3.

In some embodiments, the rear side reinforcement member 91 may be connected to the rear of the high roof panel 10 and the rear of the side roof panel 20, and may be connected to the rear of the upper portion reinforcement member 61 and the rear of the lower portion reinforcement member 71.

The rear side reinforcement member 91 may include a front joint member 93 and a rear joint member 95.

The front joint member 93 may be connected to the rear side of the upper portion reinforcement member 61 and the rear side extension member 75 of the lower portion reinforcement member 71. The rear joint member 95 may be connected to the front joint member 93.

The roof structure 100 according to an example embodiment may further include a garnish panel 99 connected to the side reinforcement members 60, as shown in FIGS. 2 and 6.

The garnish panel 99 may be disposed on both sides of the roof structure 100. In some embodiments, the garnish panel 99 is designed to provide an attractive appearance to both sides of the roof structure 100. The garnish panel 99 may, in one example, be provided as a panel of plastic material.

The garnish panel 99 may be mounted on the upper portion reinforcement member 61 and the lower portion reinforcement member 71. The garnish panel 99 may be connected to mounting holes 61a and 71a (see FIG. 8A) formed in the upper portion reinforcement member 61 and the lower portion reinforcement member 71 via mounting clips 61b and 71b (see FIG. 6).

The garnish panel 99, without being mounted on the side roof panel 20, may be connected to the upper portion reinforcement member 61 and the lower portion reinforcement member 71 via the mounting clips 61b and 71b.

Hereinafter, an assembly process and operation of a roof structure 100 according to some example embodiments configured as described above will be described in detail referring to FIGS. 1 to 11.

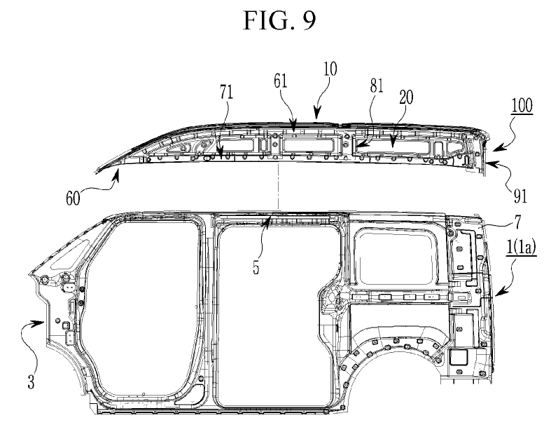

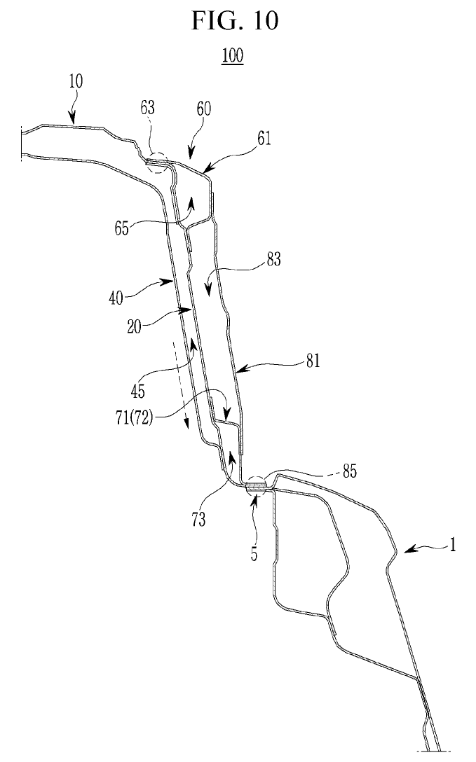

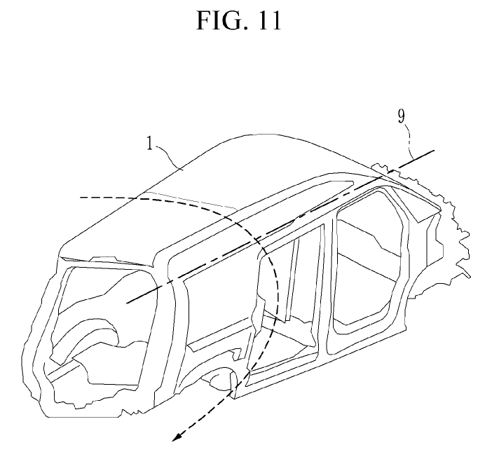

FIGS. 9 and 10 are drawings for explaining an assembly process of a roof structure according to some example embodiments. FIG. 11 is a drawing for explaining an operation of the roof structure according to some example embodiments.

Referring to FIGS. 3 to 5, in some embodiments, in a roof assemble line, the high roof panel 10, the side roof panel 20, the transverse direction reinforcement members 30, the transverse direction extension members 40, the longitudinal direction reinforcement members 50, and the side reinforcement members 60 may be provided.

In an example embodiment, a process of joining the transverse direction extension members 40 to both ends of the transverse direction reinforcement members 30 and joining the longitudinal direction reinforcement members 50 to the transverse direction reinforcement members 30 may be performed.

A process may be performed to attach the high roof panel 10 to the transverse direction reinforcement members 30 and the longitudinal direction reinforcement members 50, and to attach the side roof panel 20 to the transverse direction extension members 40. The side roof panel 20 may be connected to both sides of the high roof panel 10.

A process may be performed to attach the upper portion reinforcement member 61, the lower portion reinforcement member 71, the vertical side reinforcement members 81, and the rear side reinforcement member 91 of the side reinforcement members 60 to the side roof panel 20.

The assembly of the roof structure 100 may be completed by the process described above in the roof assembly line.

In some embodiments, the upper closed section 65 is formed between the side roof panel 20 and the upper portion reinforcement member 61, and the lower closed section 73 is formed between the side roof panel 20 and the lower portion reinforcement member 71.

In some embodiments, the cross-section of the upper closed section 65 and the cross-section of the lower closed section 73 are connected in the vertical direction through the vertical side reinforcement members 81. In some embodiments, the inner closed sections 45 are formed between the transverse direction extension members 40 and the side roof panel 20, and the outer closed sections 83 are formed between the vertical side reinforcement members 81 and the side roof panel 20.

According to the roof structure 100 according to some example embodiments, the roof strength of the high roof panel 10 and the side roof panel 20 may be reinforced by the transverse direction reinforcement members 30, the transverse direction extension members 40, the longitudinal direction reinforcement members 50, and the side reinforcement members 60.

In some embodiments, the roof structure 100, which is assembled separately in the roof assemble line, is transported to the vehicle body assemble line and may be mounted on the upper portion of the vehicle body 1 in the vehicle body assemble line.

In the vehicle body assemble line, as shown in FIGS. 9 and 10, the lower portion reinforcement member 71 and the lower portion of the side roof panel 20, which are joined together, may be loaded onto the roof side 5 of the vehicle body 1.

In this state, the process of joining the lower portion reinforcement member 71, the side roof panel 20, and the roof side 5 may be performed. The lower portion of the lower portion reinforcement member 71, the lower portion of the side roof panel 20, and the roof side 5 may be connected via the 3-layer joint 85.

A process of attaching the garnish panel 99, as shown in FIG. 6, to the upper portion reinforcement member 61 and the lower portion reinforcement member 71 via the mounting clips 61b and 71b may be performed.

According to the roof structure 100 assembled on the vehicle body 1 according to some example embodiments, the cross-sections connected in the vehicle body front-rear direction, vehicle width direction, and vertical direction may be connected to the upper portion of the vehicle body 1.

According to the roof structure 100 according to some example embodiments, the lower portion reinforcement member 71 of the side reinforcement members 60 may be provided as the reinforcing axis 72 for reinforcing the strength of the bending axis 9 along the front-rear direction of the vehicle body 1, as shown in FIG. 11.

The bending axis 9 may be referred to as the deformation center axis of the vehicle body 1 that is torsionally deformed by the load of the roof structure 100 mounted on the roof side 5 of the vehicle body 1, in which the rear opening (the dotted line portion in FIG. 11) is increased by applying a high roof structure.

According to the roof structure 100 according to some embodiments, the torsional deformation of the vehicle body 1 may be minimized by the cross-sections connected in multiple directions, and the skeletal strength of the vehicle body 1 may be strengthened.

According to the roof structure 100 according to some embodiments, the NVH (noise, vibration, and harshness) performance and collision performance of the vehicle may be improved by forming load paths connected to the vehicle body 1 in multiple directions.

According to the roof structure 100 according to some embodiments, the garnish panel 99 may not be mounted on the side roof panel 20, but may be connected to the upper portion reinforcement member 61 and the lower portion reinforcement member 71.

In some embodiments, because the mounting hole for mounting the garnish panel 99 is not machined in the side roof panel 20, moisture may be prevented from inflowing into the vehicle through the mounting hole, thereby enhancing the vehicle’s watertight performance.

The roof structure 100 according to some embodiments may be assembled separately in a roof assemble line and mounted an upper portion of a vehicle body 1 in a vehicle body assemble line.

The roof structure 100 according to some embodiments may be mounted on the vehicle body 1 that is not replaced even if the vehicle type of the vehicle is changed, for example, on the roof side 5 of a basic vehicle body that is not a high roof type.

The roof structure 100 according to some embodiments may be replaced depending on the intended use of the vehicle and the specifications of the basic vehicle body, and may be manufactured in various shapes and sizes.

Accordingly, according to the roof structure 100 according to some embodiments, because the basic vehicle body of various vehicle types may be commonized, the development period and investment cost of the vehicle body may be reduced, and the design and production cost of the vehicle body may be lowered.

While this present disclosure has been described in connection with what is presently considered to be some practical example embodiments, it may be understood that the present disclosure is not necessarily limited to the disclosed example embodiments. On the contrary, the present disclosure is intended to cover various modifications and equivalent arrangements included within the spirit and scopes of the appended claims and equivalents thereof.

What is claimed is:

1. A roof structure comprising:
a high-roof panel;
side roof panels disposed on lateral sides of the high-roof panel, wherein the high-roof panel is disposed at a height difference from an upper portion of a vehicle body by the side roof panels; and
transverse direction reinforcement members connected to a lower portion of the high-roof panel along a front-rear direction of the vehicle body, and longitudinal direction reinforcement members connected to the lower portion of the high-roof panel.

2. The roof structure of claim 1, further comprising transverse direction extension members connected to ends of the transverse direction reinforcement members, respectively, and connected along a vertical direction at an inner surface of each of the side roof panels.

3. The roof structure of claim 2, further comprising side reinforcement members connected at an outer surface of each of the side roof panels, respectively, and connected to the upper portion of the vehicle body through a lower portion of each of the side roof panels.

4. The roof structure of claim 3, further comprising garnish panels connected to each of the side reinforcement members, respectively.

5. The roof structure of claim 1, wherein longitudinal direction reinforcement members are disposed between the transverse direction reinforcement members and are connected to the transverse direction reinforcement members by joint forming parts at both front and rear ends of the longitudinal direction reinforcement members.

6. The roof structure of claim 1, wherein the vehicle body is equipped with a common vehicle body with a roof side disposed upper portions of side structures of the vehicle body.

7. A roof structure comprising:
a high-roof panel disposed at a height difference from a roof side of a vehicle body;
a side roof panel connected to the high-roof panel and connected to a roof side of the vehicle body such that the side roof panel is disposed between the high-roof panel and the roof side of the vehicle body; and
a side reinforcement member connected to the side roof panel along a front-rear direction and a vertical direction of the vehicle body, and the side reinforcement member being connected to the roof side of the vehicle body at a lower portion of the side roof panel.

8. The roof structure of claim 7, wherein the side reinforcement member comprises:
an upper portion reinforcement member connected along the front-rear direction of the vehicle body to an upper portion of the side roof panel and connected to the high-roof panel;
a lower portion reinforcement member connected to the lower portion of the side roof panel along the front-rear direction of the vehicle body; and
vertical side reinforcement members connected to the upper portion reinforcement member and the lower portion reinforcement member and extending along the vertical direction of the vehicle body.

9. The roof structure of claim 8, wherein a side portion of the high-roof panel, the upper portion of the side roof panel, and an upper portion of the upper portion reinforcement member are connected through a 3-layer joint.

10. The roof structure of claim 8, wherein the lower portion reinforcement member is connected to the roof side of the vehicle body at the lower portion of the side roof panel and is configured to provide a reinforcing axis that reinforces the strength of a bending axis along a forward and backward direction of the vehicle body.

11. The roof structure of claim 8, further comprising:
an upper closed section between the side roof panel and the upper portion reinforcement member; and
a lower closed section between the side roof panel and the lower portion reinforcement member.

12. The roof structure of claim 8, wherein at a position corresponding to the vertical side reinforcement members, transverse direction extension members are connected in the vertical direction to an inner surface of the side roof panel, respectively.

13. The roof structure of claim 12, further comprising:
inner closed sections between the transverse direction extension members and the side roof panel; and
outer closed sections are formed between the vertical side reinforcement members and the side roof panel.

14. The roof structure of claim 8, wherein the side reinforcement member further comprises a rear side reinforcement member connected to the rear of the high-roof panel and the rear of the side roof panel, and connected to the rear of the upper portion reinforcement member and the rear of the lower portion reinforcement member.

15. The roof structure of claim 14, wherein:
the upper portion reinforcement member includes a front side extension member disposed at the front of the vehicle body and connected to a front portion of the lower portion reinforcement member; and
the lower portion reinforcement member includes a rear side extension member disposed at the rear of the vehicle body and connected to the rear side reinforcement member.

16. The roof structure of claim 15, wherein the rear side reinforcement member comprises:
a front joint member connected to the rear of the upper portion reinforcement member and the rear side extension member; and
a rear joint member connected to the front joint member.

17. The roof structure of claim 8, wherein the roof side of the vehicle body, the side roof panel, and the lower portion reinforcement member are connected through a 3-layer joint.

18. The roof structure of claim 8, further comprising a garnish panel connected to the upper portion reinforcement member and the lower portion reinforcement member.

19. The roof structure of claim 18, wherein the garnish panel is connected via mounting clips to mounting holes in the upper portion reinforcement member and the lower portion reinforcement member.

20. A modular vehicle comprising:
a side structure of a common vehicle body;
a modular roof structure configured to fit the common vehicle body, the modular roof structure comprising:
a side roof panel,
a side reinforcement member connected to the side roof panel along a front-rear direction and a vertical direction of the common vehicle body, and the side reinforcement member being connected to a roof side of the common vehicle body at a lower portion of the side roof panel,
a high-roof panel connected to the side roof panel a lateral side of the high-roof panel, and the high-roof panel being disposed at a height difference from an upper portion of the common vehicle body by the side roof panel, and
transverse direction reinforcement members connected to a lower portion of the high-roof panel along a front-rear direction of the common vehicle body, and longitudinal direction reinforcement members connected to the lower portion of the high-roof panel, wherein side ends of the transverse direction reinforcement members are connected to the side reinforcement member.
